(19) United States
(12) Patent Application Publication
(10) Pub. No.: US 2023/0114639 A1
(43) Pub. Date: Apr. 13, 2023

(54) DYNAMICALLY RECONFIGURED DARK RIDE SYSTEM AND METHODS

(71) Applicant: Oceaneering International, Inc., Houston, TX (US)

(72) Inventor: Clifford Allen JENNINGS, Highland, MD (US)

(73) Assignee: Oceaneering International, Inc., Houston, TX (US)

(21) Appl. No.: 17/963,640

(22) Filed: Oct. 11, 2022

Related U.S. Application Data
(60) Provisional application No. 63/254,409, filed on Oct. 11, 2021.

(51) Int. Cl. A63G 31/02; A63J 1/02; A63J 11/00; G05D 1/02

(52) U.S. Cl. CPC A63G 31/02; A63J 1/02; A63J 11/00; G05D 1/0287; G05D 1/0212

(57) ABSTRACT

Dark ride system 1 typically comprises a ride space; a set of wirelessly-controlled and tracklessly-guided passenger vehicle platforms 10 dispatchable within the ride space; a set of wirelessly-controlled and tracklessly-guided themed scenery vehicle platforms dispatchable within the ride space; a load and unload area for passengers disposed proximate the ride space; and a control system. A predetermined set of passengers is allowed to board a predetermined subset of the set of wirelessly-controlled and tracklessly-guided passenger vehicle platforms at the load and unload area and the set of wirelessly-controlled and tracklessly-guided themed scenery vehicle platforms dispatched in an initial spatial arrangement at one or more predetermined times. During a ride show, the control system choreographs and changes a predetermined subset of the set of wirelessly-controlled and tracklessly-guided themed scenery vehicle platforms. At a conclusion of the ride show, the predetermined set of passengers are allowed to exit.

### RELATION TO OTHER APPLICATIONS

This application claims priority through U.S. Provisional Application 63/254,409 filed on Oct. 11, 2020.

### BACKGROUND

Dark ride systems can provide an immersive amusement ride experience but may also require a large amount of space and one or more tracks, track switches, track-related sensors or trenching. Some require use of “super-flat” flooring such as concrete. These can all add to the cost and complexity of providing a dark ride amusement ride experience.

### FIGURES

Various figures are included herein which illustrate aspects of embodiments of the disclosed inventions.

FIG. 1 is a top-down plan view of an exemplary dark ride system;

FIG. 2 is a top-down view of an exemplary dark ride system in partial perspective;

FIG. 3 is a top-down plan view of an exemplary dark ride system in partial perspective showing passenger vehicles interacting on a main operating floor;

FIG. 4 is a top-down plan view of an exemplary dark ride system in partial perspective showing scene transmorphing during diversion of passenger attention;

FIG. 5 is a top-down plan view of an exemplary dark ride system in partial perspective showing passenger vehicle isolation in a rearranged ride show scene;

FIG. 6 is a top-down plan view of an exemplary dark ride system in partial perspective showing an animated character reveal to passenger vehicles;

FIG. 7 is a top-down plan view of an exemplary dark ride system in partial perspective showing an animated character reveal to passenger vehicles from a passenger perspective;

FIG. 8 is a top-down plan view of an exemplary dark ride system in partial perspective showing dynamic scene change, splitting passenger vehicles into groups;

FIG. 9 is a top-down plan view of an exemplary dark ride system in partial perspective showing rearrangement of scene elements into a large floor space;

FIG. 11 is a top-down plan view of an exemplary dark ride system in partial perspective showing passenger vehicles returning to an unload/load area;

FIG. 12 is a view in partial perspective of an exemplary passenger vehicle; and

FIG. 13 is a block diagram of an exemplary controller.

### DESCRIPTION OF EXEMPLARY EMBODIMENTS

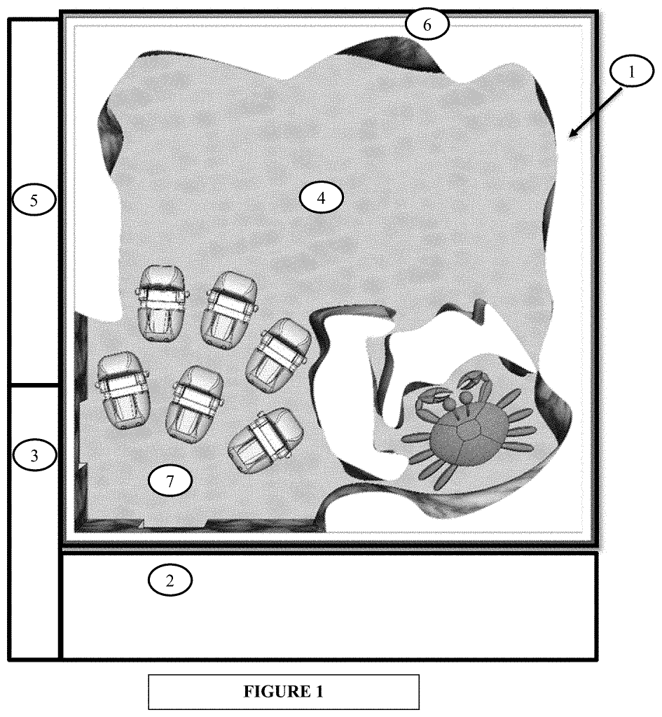

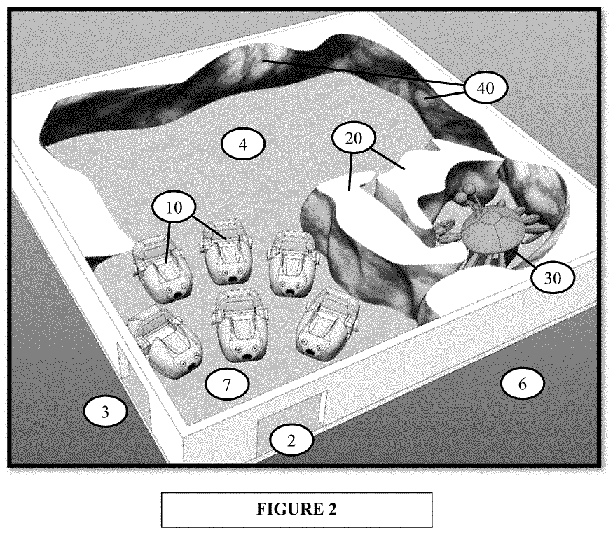

In a first embodiment, referring generally to FIG. 1 and FIG. 2, dark ride system 1 typically comprises ride space 4; a set of wirelessly-controlled and tracklessly-guided passenger vehicle platforms 10 dispatchable within ride space 4; a set of wirelessly-controlled and tracklessly-guided themed scenery vehicle platforms 20 dispatchable within the ride space, each capable of carrying a section or element of themed scenery; load and unload area 7 for passengers disposed proximate ride space 4; and control system 5. Additionally, static elements such as physical and/or projected scenery (not specifically shown in the figures) may be disposed within or proximate to ride space 4.

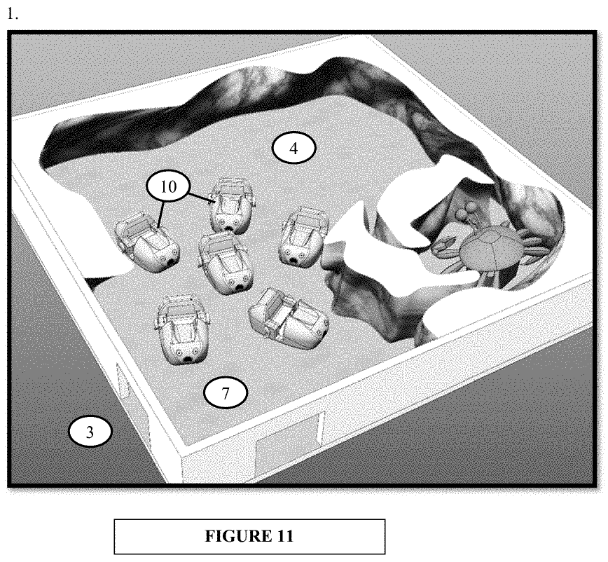

Typically, referring additionally to FIG. 12, each wirelessly-controlled and tracklessly-guided passenger vehicle platform 10 comprises vehicle motive system 10A comprising a mechanical motion generator and a vehicle transporter; vehicle motion controller 10B operatively in communication with the vehicle motive system 10A; and passenger accommodation area 11. The mechanical motion generator is typically configured to impart rotational or translational motion upon passenger accommodation area 11 in a plurality of degrees of freedom, such as yaw, pitch, roll and surge.

Referring back to FIG. 1 and FIG. 2, a predetermined subset of the set of wirelessly-controlled and tracklessly-guided themed scenery vehicle platforms 20 may comprise equipment (not shown in the figures) to actuate a joint, illuminate a feature, project a sound, display video imagery, operate a special effect, as necessary for the story involved in the ride show.

In embodiments, ride system 1 comprises an area of around 62 feet×62 feet (18.9 meters×18.9 meters).

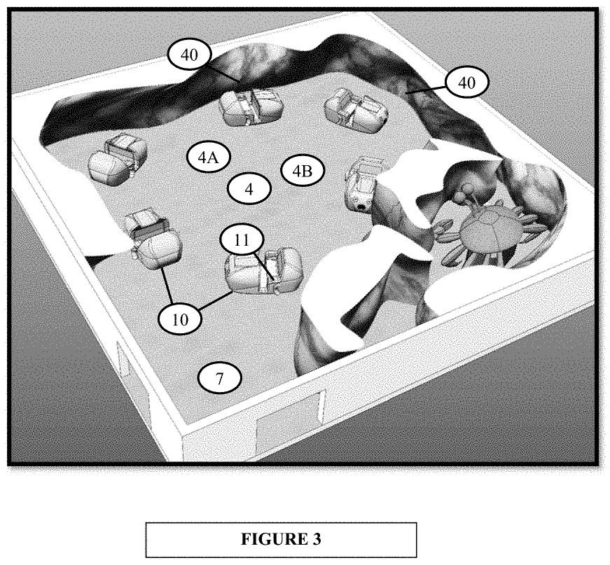

Referring additionally to FIG. 3, in embodiments, ride space 4 comprises or otherwise defines a space divided in scenic areas 4A,4B, each with its own aesthetic treatments and set of wirelessly-controlled and tracklessly-guided themed scenery vehicle platforms 20. The treatments may be such as natural treatments (e.g., undersea, mountains, caves, or the like, or a combination thereof), man-made treatments (e.g., buildings, dungeons, ships, cities, or the like, or a combination thereof), fantastical treatments (e.g., sci-fi, castles, fairy-tale settings, or the like, or a combination thereof), or the like, or a combination thereof.

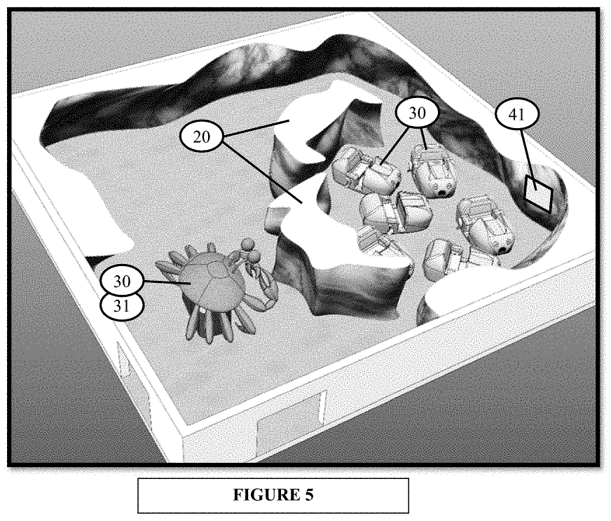

Referring additionally to FIG. 5, ride space 4 may be dynamically reconfigured during a ride show, permitted the same space to be reconfigured for different scenes and allowing a plurality of scenes to share the same footprint, thus allowing a reasonably elaborate overall show to fit within a comparatively small facility.

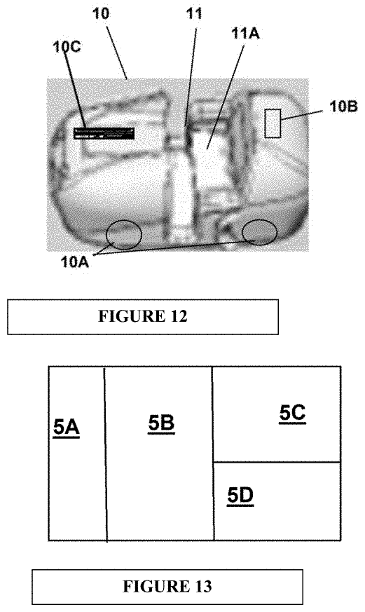

Referring additionally to FIG. 13, control system 5 typically comprises one or more scenery-bearing vehicle controllers 5A operatively in communication with the set of wirelessly-controlled and tracklessly-guided themed scenery vehicle platforms 20 (FIG. 2) and adapted to control the set of wirelessly-controlled and tracklessly-guided themed scenery vehicle platforms 20 during a show to form a plurality of variously-shaped areas within ride space 4, presenting varying aspects of mobile scenery at differing times to passengers; passenger vehicle platform controller 5B operatively in communication with the set of wirelessly-controlled and tracklessly-guided passenger vehicle platforms 10 (FIG. 2) and adapted to control the set of wirelessly-controlled and tracklessly-guided passenger vehicle platforms 10 through changing scenery during a show; and show element controller 5C, comprising an environment controller adapted to control aspects of lighting, projection, audio and scenery, typically using one or more sub-controllers.

Referring back to FIG. 1 and FIG. 2, in embodiments ride space 4 further comprises a predetermined set of static elements such as physical scenery 40,42 or projected scenery 41 disposed at least partially within ride space 4.

Typically, each wirelessly-controlled and tracklessly-guided passenger vehicle platform 10 dispatchable comprises passenger area 11 (FIG. 12) which can accommodate one or more passengers.

In most embodiments, the set of wirelessly-controlled and tracklessly-guided themed scenery vehicle platforms 20 are capable of moving independently with respect to, but in coordination with, movement of wirelessly-controlled and tracklessly-guided passenger vehicle platforms 10.

In embodiments, dark ride system 1 further comprises a set of wirelessly-controlled and tracklessly-guided figure vehicle platforms 30 dispatchable within ride space 4. In these embodiments, control system 5 further comprises one or more figure vehicle platform controllers 5D (FIG. 13) operatively in communication with the set of wirelessly-controlled and tracklessly-guided figure vehicle platforms 30 and adapted to control the set of wirelessly-controlled and tracklessly-guided figure vehicle platforms 30 through changing scenery during a show.

The set of wirelessly-controlled and tracklessly-guided figure vehicle platforms 30 may comprise an animation-bearing vehicle platform 30 adapted for visual interaction with passengers in the set of wirelessly-controlled and tracklessly-guided passenger vehicle platforms 10.

Ride space 4 is typically configured to allow movement of the set of wirelessly-controlled and tracklessly-guided themed scenery vehicle platforms 20 during a show. This movement of the set of wirelessly-controlled and tracklessly-guided themed scenery vehicle platforms 20 will typically reconfigure ride space 4 for different scenes, thus allowing a plurality of scenes to share the same footprint.

In the operation of exemplary methods, referring back to FIG. 1, a ride experience may be provided using ride system 1, as described above, by allowing a predetermined set of passengers to board a predetermined subset of the set of wirelessly-controlled and tracklessly-guided passenger vehicle platforms 10 dispatchable within ride space 4 at load and unload area for passengers 7. The set of wirelessly-controlled and tracklessly-guided themed scenery vehicle platforms 20 are positioned into an initial spatial arrangement within ride space 4, typically before the set of wirelessly-controlled and tracklessly-guided passenger vehicle platforms 10 are dispatched within ride space 4. Using controller 5, lighting, projection, audio and other show elements related to an overall ride-show experience during a ride show are controlled and the set of wirelessly-controlled and tracklessly-guided passenger vehicle platforms 10 dispatched into ride space 4 at a predetermined time into the ride show.

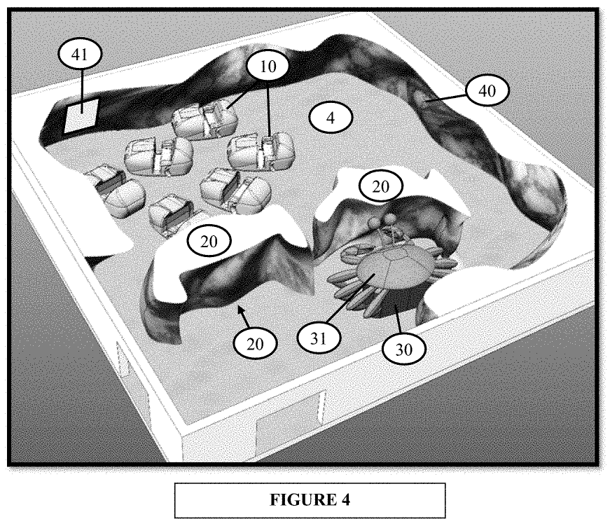

As the passengers in their wirelessly-controlled and tracklessly-guided passenger vehicle platforms 10 are made to face one area of scenery defined by the set of wirelessly-controlled and tracklessly-guided themed scenery vehicle platforms 20, e.g., FIG. 3, control system 5 is used to mutually and cooperatively choreograph and change a predetermined subset of the set of wirelessly-controlled and tracklessly-guided themed scenery vehicle platforms 20 during the ride show. The set of wirelessly-controlled and tracklessly-guided themed scenery vehicle platforms 20 may be controlled during a ride show to form a plurality of variously-shaped areas, presenting varying aspects of the mobile scenery at differing times to passengers, e.g., FIGS. 4-5.

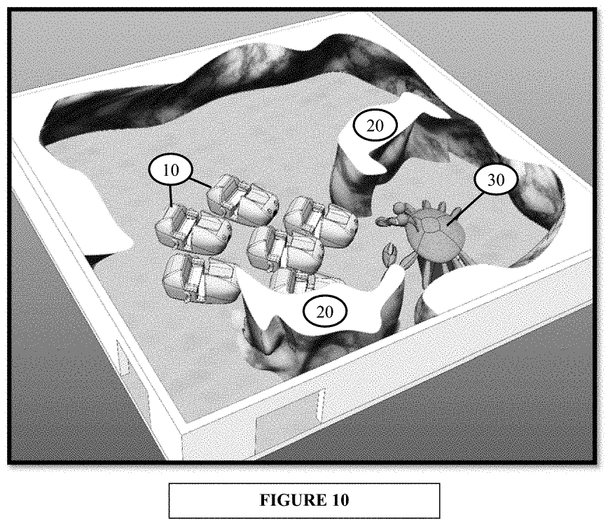

At a conclusion of the ride show, e.g., FIG. 11, control system 5 (FIG. 2) is used to position the set of wirelessly-controlled and tracklessly-guided vehicle passenger platforms 10 at unload area 7 and the predetermined set of passengers allowed to exit the set of wirelessly-controlled and tracklessly-guided vehicle passenger platforms 10 at unload area 7.

In certain embodiments, one or more passengers are allowed to interact with ride space 4 and an area or sequence of the ride show made to respond to the passenger interaction such as by controller system 5.

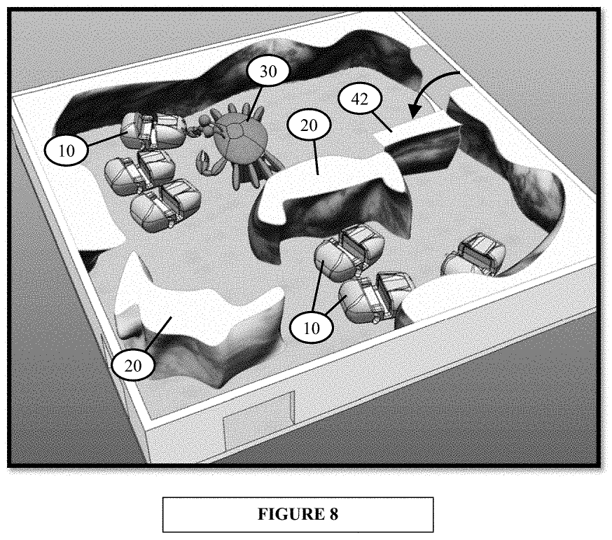

Typically, the ride show starts with the set of wirelessly-controlled and tracklessly-guided passenger vehicle platforms 10 grouped together in groups, e.g., FIG. 4 and FIG. 8, and, as the ride show commences the set of wirelessly-controlled and tracklessly-guided passenger vehicle platforms 10 are moved away from each other e.g., FIG. 8, and the set of wirelessly-controlled and tracklessly-guided passenger vehicle platforms 10 recombined into different group arrangements.

In certain embodiments, the set of wirelessly-controlled and tracklessly-guided passenger vehicle platforms 10 are dispatched into ride space 4 in groups through a plurality of show spaces 4A,4B within ride space 4, where each show space is provided with its own set of wirelessly-controlled and tracklessly-guided themed scenery vehicle platforms 20 and each group simultaneously cycles through the ride show, with the result being multiplied throughput.

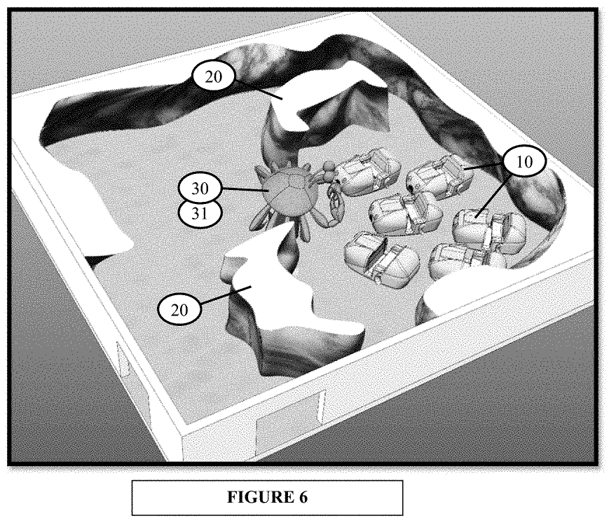

Control system 5 may move the set of wirelessly-controlled and tracklessly-guided themed scenery vehicle platforms 20 in such a way as to open or close a passage, reduce or increase the size of a space, and hide or reveal a story element where such reveal may be dramatic e.g., FIG. 5 and FIG. 6.

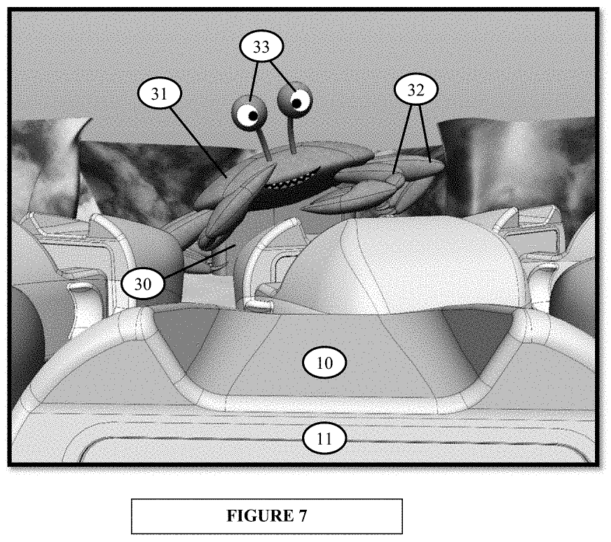

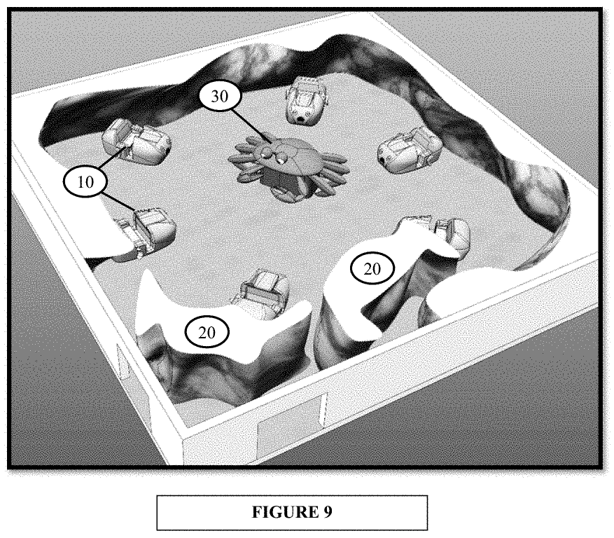

Referring generally to FIG. 2-FIG. 10, in embodiments comprising the set of wirelessly-controlled and tracklessly-guided figure vehicle platforms 30 which comprise an animation-bearing vehicle 31 (FIG. 6) adapted for visual interaction with passengers, animation-bearing vehicle 31 is typically dispatched at an initial location within ride space 4, e.g., at a beginning of the ride show, and hidden from passenger view by one or more wirelessly-controlled and tracklessly-guided themed scenery vehicle platforms 20 of the set of wirelessly-controlled and tracklessly-guided themed scenery vehicle platforms 20. At a predetermined time, animation-bearing vehicle 31, wirelessly-controlled and tracklessly-guided themed scenery vehicle platform 20, or both animation-bearing vehicle 31 and wirelessly-controlled and tracklessly-guided themed scenery vehicle platform 20 move to reveal animation-bearing vehicle 31. Animation-bearing vehicle 31 may comprise dynamically controllable features and/or static features, e.g., features 32-33 (FIG. 7).

In embodiments, wirelessly-controlled and tracklessly-guided themed scenery vehicle platform 20 comprises two or more wirelessly-controlled and tracklessly-guided themed scenery vehicle platforms 20. In these embodiments, moving animation-bearing vehicle 31, wirelessly-controlled and tracklessly-guided themed scenery vehicle platform 20, or both animation-bearing vehicle 31 and wirelessly-controlled and tracklessly-guided themed scenery vehicle platform 20 may comprise positioning the plurality of wirelessly-controlled and tracklessly-guided themed scenery vehicle platforms 20 intermediate animation-bearing vehicle 31 and one or more wirelessly-controlled and tracklessly-guided passenger vehicle platforms 10 of the set of wirelessly-controlled and tracklessly-guided passenger vehicle platforms 10 (FIG. 2) and moving the plurality of wirelessly-controlled and tracklessly-guided themed scenery vehicle platforms 20 away from each other at a predetermined time (FIG. 6).

In certain of embodiments, wirelessly-controlled and tracklessly-guided themed scenery vehicle platform 20 may comprise a plurality of wirelessly-controlled and tracklessly-guided themed scenery vehicle platforms 20 configured to appear passengers as a solid impenetrable surface when initially disposed within the ride space 4 (FIG. 2).

In various embodiments, a ride show may be initiated with the set of wirelessly-controlled and tracklessly-guided passenger vehicle platforms 10 surrounded by or intermixed with the set of wirelessly-controlled and tracklessly-guided themed scenery vehicle platforms 20, such as by having a physical and/or projected walking surface, e.g., a moving surface set, and scenery, e.g., rocks, foliage, architecture, or the like, or a combination thereof, define an initial appearance of a combined whole, e.g., having the walking surface disposed atop the set of wirelessly-controlled and tracklessly-guided themed scenery vehicle platforms 20 and/or raised above a vehicle operating floor. In these embodiments, as the set of wirelessly-controlled and tracklessly-guided passenger vehicle platforms 10 move and break away from each other, the walking surface is allowed to depart with a predetermined subset of set of wirelessly-controlled and tracklessly-guided themed scenery vehicle platforms 20.

Referring generally to FIG. 12, in embodiments, passenger accommodation area 11 comprises one or more exposed benches 11A and the set of wirelessly-controlled and tracklessly-guided passenger vehicle platforms 10 is initially grouped to appear as a theater comprising a predetermined number of these benches 11A. In these embodiments, as the ride show begins, a predetermined set of actions are made to occur in front of the set of wirelessly-controlled and tracklessly-guided passenger vehicle platforms 10, such as on a stage or projected on a screen. As the ride show progresses, the set of wirelessly-controlled and tracklessly-guided passenger vehicle platforms 10 are moved into separately spaced and cooperatively coordinated wirelessly-controlled and tracklessly-guided passenger vehicle platforms 10 and ride controller 5 is programmed to send each wirelessly-controlled and tracklessly-guided passenger vehicle platform 10 into other or separate story spaces in a choreographed manner.

In any embodiment, audio, lighting, projection and other resources may be shared between scenes.

In certain embodiments, one or more wirelessly-controlled and tracklessly-guided vehicle passenger platforms 10 are made to face a first area of scenery and a configuration of a predetermined number of the set of wirelessly-controlled and tracklessly-guided themed scenery vehicle platforms 20 and/or elements of themed scenery changed behind or otherwise out of the sight of wirelessly-controlled and tracklessly-guided vehicle passenger platforms 10. This can be accomplished using ride controller 5 to control the set of wirelessly-controlled and tracklessly-guided themed scenery vehicle platforms 20 and/or elements of themed scenery during a ride show to form a plurality of variously-shaped areas. In these embodiments, presenting varying aspects of the mobile scenery at differing times to passengers further comprises reconfiguring the set of wirelessly-controlled and tracklessly-guided themed scenery vehicle platforms 20 and/or elements of themed scenery during a ride show for different scenes.

In an embodiment, two or more of the set of wirelessly-controlled and tracklessly-guided themed scenery vehicle platforms 20 and/or elements of themed scenery may be paired or otherwise associated to present an apparently solid area and be unpaired or otherwise disassociated to create a desired predetermined effect such as opening or closing a passageway through which wirelessly-controlled and tracklessly-guided vehicle passenger platform 10 may be moved, reducing or increasing a size of a ride space, hiding or revealing a story element, or the like, or a combination thereof

Where the predetermined set of wirelessly-controlled and tracklessly-guided vehicle passenger platforms 10 comprises a plurality of wirelessly-controlled and tracklessly-guided vehicle passenger platforms 10, ride controller 5 may be used to control wirelessly-controlled and tracklessly-guided vehicle passenger platforms 10 through changing scenery during a ride show by running the plurality of wirelessly-controlled and tracklessly-guided vehicle passenger platforms 10 in groups or platoons through a plurality of show spaces, where each space may have its own mobile scenery, and allowing each platoon to simultaneously cycle through the ride.

In embodiments, using ride controller 5 further comprises controlling the set of wirelessly-controlled and tracklessly-guided themed scenery vehicle platforms 20 during a show to dynamically form a plurality of variously-shaped areas, presenting varying aspects of the mobile scenery at differing times to passengers, either stochastically or deterministically.

The set of wirelessly-controlled and tracklessly-guided themed scenery vehicle platforms 20 may be used during a show to actuate a joint, illuminate a feature, project a sound, display video imagery, operate a special effect as necessary for a story involved, or the like, or a combination thereof.

Using wirelessly-controlled and tracklessly-guided themed scenery vehicle platforms 20 during a ride show may comprise creating a show in ride space 4 which is divided into scenic areas using wirelessly-controlled and tracklessly-guided themed scenery vehicle platforms 20, each of which may comprise its own aesthetic treatments and mobile wirelessly-controlled and tracklessly-guided themed scenery vehicle platforms 20.

In embodiments, load area 7 changes size, e.g., becomes larger or smaller, as walls 42 move outward by using with a plurality of rows of mobile wall sections which move away, spread, and combine into a single wall 42.

In embodiments, the set of wirelessly-controlled and tracklessly-guided themed scenery vehicle platforms 20 may be arranged as a maze, and passengers allowed to make choices of which paths within the maze to take. Ride controller 5 may be used to change maze components arrangement as the set of wirelessly-controlled and tracklessly-guided passenger vehicle platforms 10 progress within the maze. The show may, at the end of this sequence, cause all maze components to withdraw and allow the set of wirelessly-controlled and tracklessly-guided passenger vehicle platforms 10 to proceed from them.

In certain embodiments, the set of wirelessly-controlled and tracklessly-guided themed scenery vehicle platforms 20, the set of wirelessly-controlled and tracklessly-guided vehicle passenger platforms 10, or both carry portions of buildings (either or both of interior or exterior portions). The portions of buildings may be dynamically arranged to present a different scene or room or building on the opposite side.

In embodiments, one or more passengers may be allowed to dynamically interact with the ride show such as via on-board laser-shooting equipment 10C (FIG. 12) present in or attached to wirelessly-controlled and tracklessly-guided passenger vehicle platform 10 and one or more areas and/or ride show sequences made to respond to the passenger's dynamic interaction, e.g., by scoring. The interaction may then lead to a further, e.g., “bonus,” set of ride scenes made available to the passengers.

The foregoing disclosure and description of the inventions are illustrative and explanatory. Various changes in the size, shape, and materials, as well as in the details of the illustrative construction and/or an illustrative method may be made without departing from the spirit of the invention.

1. A dark ride system, comprising:
a) a ride space;
b) a set of wirelessly-controlled and tracklessly-guided passenger vehicle platforms dispatchable within the ride space, each wirelessly-controlled and tracklessly-guided passenger vehicle platform comprising:
i) a passenger accommodation area;
ii) a vehicle motive system, comprising:
(1) a mechanical motion generator configured to impart rotational or translational motion upon the passenger accommodation area in a plurality of degrees of freedom; and
(2) a vehicle transporter; and
iii) a vehicle motion controller operatively in communication with the vehicle motive system;
c) a set of wirelessly-controlled and tracklessly-guided themed scenery vehicle platforms dispatchable within the ride space;
d) a load and unload area for passengers disposed proximate the ride space; and
e) a control system, comprising:
i) a scenery-bearing vehicle controller operatively in communication with the set of wirelessly-controlled and tracklessly-guided themed scenery vehicle platforms and adapted to control the set of wirelessly-controlled and tracklessly-guided themed scenery vehicle platforms during a show to form a plurality of variously-shaped areas within the ride space presenting varying aspects of mobile scenery at differing times to passengers;
ii) a passenger vehicle platform controller operatively in communication with the set of wirelessly-controlled and tracklessly-guided passenger vehicle platforms and adapted to control the set of wirelessly-controlled and tracklessly-guided passenger vehicle platforms through changing scenery during a show; and
iii) a show element controller, comprising an environment controller.

2. The ride vehicle system of claim 1, further comprising a predetermined set of static elements disposed at least partially within the ride space.

3. The ride vehicle system of claim 1, wherein:
a) the system further comprises a set of wirelessly-controlled and tracklessly-guided figure vehicle platforms selectively and controllably dispatchable within the ride space; and
b) the control system further comprises a figure vehicle platform controller operatively in communication with the set of wirelessly-controlled and tracklessly-guided figure vehicle platforms and adapted to control the set of wirelessly-controlled and tracklessly-guided figure vehicle platforms through changing scenery during a show.

4. The ride system of claim 3 wherein the set of wirelessly-controlled and tracklessly-guided figure vehicle platforms comprises an animation-bearing vehicle adapted for visual interaction with passengers.

5. The ride system of claim 1, wherein the ride space is configured to allow movement of the set of wirelessly-controlled and tracklessly-guided themed scenery vehicle platforms during a show to reconfigure the ride space for different scenes and allowing a plurality of scenes to share the same footprint.

6. The ride system of claim 1, wherein the ride space comprises a space divided into scenic areas, each with its own aesthetic treatments and set of wirelessly-controlled and tracklessly-guided themed scenery vehicle platforms.

7. A method of providing a ride experience, using a dark ride system comprising a ride space;
a set of wirelessly-controlled and tracklessly-guided passenger vehicle platforms dispatchable within the ride space, each wirelessly-controlled and tracklessly-guided passenger vehicle platform comprising a passenger accommodation area, a vehicle motive system which comprises a mechanical motion generator configured to impart rotational or translational motion upon the passenger accommodation area in a plurality of degrees of freedom, and a vehicle transporter, and a vehicle motion controller operatively in communication with the vehicle motive system; a set of wirelessly-controlled and tracklessly-guided themed scenery vehicle platforms dispatchable within the ride space; a load and unload area for passengers disposed proximate the ride space; and a control system which comprises a scenery-bearing vehicle controller operatively in communication with the set of wirelessly-controlled and tracklessly-guided themed scenery vehicle platforms and adapted to control the set of wirelessly-controlled and tracklessly-guided themed scenery vehicle platforms during a show to form a plurality of variously-shaped areas within the ride space presenting varying aspects of mobile scenery at differing times to passengers, a passenger vehicle platform controller operatively in communication with the set of wirelessly-controlled and tracklessly-guided passenger vehicle platforms and adapted to control the set of wirelessly-controlled and tracklessly-guided passenger vehicle platforms through changing scenery during a show, and a show element controller, comprising an environment controller, the method comprising:
a) allowing a predetermined set of passengers to board a predetermined subset of the set of wirelessly-controlled and tracklessly-guided passenger vehicle platforms dispatchable within the ride space at the load and unload area for passengers;
b) positioning the set of wirelessly-controlled and tracklessly-guided themed scenery vehicle platforms dispatchable within the ride space into an initial spatial arrangement within the ride space;
c) using the control system to control lighting, projection, audio and other show elements related to the overall ride-show experience during a ride show;
d) dispatching the set of wirelessly-controlled and tracklessly-guided passenger vehicle platforms into the ride space at a predetermined time into the ride show;
e) as the passengers in their wirelessly-controlled and tracklessly-guided passenger vehicle platforms are made to face one area of scenery defined by the set of wirelessly-controlled and tracklessly-guided themed scenery vehicle platforms, using the control system to mutually choreograph and change a predetermined subset of the set of wirelessly-controlled and tracklessly-guided themed scenery vehicle platforms during the ride show;
f) at a conclusion of the ride show, using the control system to position the wirelessly-controlled and tracklessly-guided vehicle passenger platforms at the unload area; and
g) allowing the predetermined set of passengers to exit the wirelessly-controlled and tracklessly-guided vehicle passenger platforms at the unload area.

8. The method of claim 7, further comprising:
a) allowing a passenger to interact with the ride space; and
b) making an area or sequence of the ride show responsive to the passenger interaction.

9. The method if claim 7, further comprising:
a) dispatching the set of wirelessly-controlled and tracklessly-guided passenger vehicle platforms into the ride space in groups of wirelessly-controlled and tracklessly-guided passenger vehicle platforms through a plurality of show spaces within the ride space;
b) providing each show space with its own set of wirelessly-controlled and tracklessly-guided themed scenery vehicle platforms; and
c) allowing each group of wirelessly-controlled and tracklessly-guided passenger vehicle platforms to simultaneously cycle through the ride space during the ride show.

10. The method of claim 7, wherein the ride show starts with the set of wirelessly-controlled and tracklessly-guided passenger vehicle platforms grouped together in groups of wirelessly-controlled and tracklessly-guided passenger vehicle platforms and, as the ride show commences:
a) moving the groups of wirelessly-controlled and tracklessly-guided passenger vehicle platforms away from each other; and
b) recombining the groups of wirelessly-controlled and tracklessly-guided passenger vehicle platforms into different group arrangements during the ride show.

11. The method of claim 7, wherein the control system moves the set of wirelessly-controlled and tracklessly-guided themed scenery vehicle platforms in such a way as to open or close a passage, reduce or increase the size of a space, and hide or reveal a story element.

12. The method of claim 7, further comprising a set of wirelessly-controlled and tracklessly-guided figure vehicle platforms disposed within the ride space, the set of wirelessly-controlled and tracklessly-guided figure vehicle platforms comprising an animation-bearing vehicle adapted for visual interaction with passengers, the method further comprising:
a) disposing the animation-bearing vehicle at an initial location within the ride space at a beginning of the ride show, the animation-bearing vehicle hidden from view by a wirelessly-controlled and tracklessly-guided themed scenery vehicle platform of the set of wirelessly-controlled and tracklessly-guided themed scenery vehicle platforms; and
b) at a predetermined time, moving the animation-bearing vehicle, the wirelessly-controlled and tracklessly-guided themed scenery vehicle platform, or both the animation-bearing vehicle and the wirelessly-controlled and tracklessly-guided themed scenery vehicle platform to reveal the animation-bearing vehicle.

13. The method of claim 12, wherein:
a) the wirelessly-controlled and tracklessly-guided themed scenery vehicle platform comprises two wirelessly-controlled and tracklessly-guided themed scenery vehicle platforms; and
b) moving the animation-bearing vehicle, the wirelessly-controlled and tracklessly-guided themed scenery vehicle platform, or both the animation-bearing vehicle and the wirelessly-controlled and tracklessly-guided themed scenery vehicle platform comprises:
i) positioning the two wirelessly-controlled and tracklessly-guided themed scenery vehicle platforms intermediate the animation-bearing vehicle and a wirelessly-controlled and tracklessly-guided passenger vehicle platform of the set of wirelessly-controlled and tracklessly-guided passenger vehicle platforms; and
ii) moving the two wirelessly-controlled and tracklessly-guided themed scenery vehicle platforms away from each other at a predetermined time.

14. The method of claim 7, wherein the passenger accommodation area comprises an exposed bench and the set of wirelessly-controlled and tracklessly-guided passenger vehicle platforms are initially grouped to appear as a theater having many of these benches, the method further comprising:
a) as the ride show begins, causing a predetermined set of actions to occur in front of the set of wirelessly-controlled and tracklessly-guided passenger vehicle platforms;
b) as the ride show progresses, moving the set of wirelessly-controlled and tracklessly-guided passenger vehicle platforms into separately spaced wirelessly-controlled and tracklessly-guided passenger vehicle platforms; and
c) using the control system to send each wirelessly-controlled and tracklessly-guided passenger vehicle platform into other story spaces in a choreographed manner.

15. The method of claim 7, further comprising:
a) making a wirelessly-controlled and tracklessly-guided vehicle passenger platform face one area of scenery; and
b) changing a configuration of the wirelessly-controlled and tracklessly-guided section or element of themed scenery behind the wirelessly-controlled and tracklessly-guided vehicle passenger platform.

16. The method of claim 7, further comprising:
a) using the control system to control the predetermined set of wirelessly-controlled and tracklessly-guided themed scenery vehicle platforms during a show to form a plurality of variously-shaped areas; and
b) presenting varying aspects of the mobile scenery at differing times to passengers further comprises reconfiguring the predetermined set of wirelessly-controlled and tracklessly-guided themed scenery vehicle platforms during a show for different scenes.

17. The method of claim 7, wherein:
a) the predetermined set of wirelessly-controlled and tracklessly-guided vehicle passenger platforms comprises a plurality of wirelessly-controlled and tracklessly-guided vehicle passenger platforms; and
b) using the control system to control the set of wirelessly-controlled and tracklessly-guided vehicle passenger platforms through changing scenery during the show comprises:
i) running the plurality of wirelessly-controlled and tracklessly-guided vehicle passenger platforms in platoons through a plurality of show spaces, each space having its own mobile scenery; and
ii) allowing each platoon to simultaneously cycle through the ride show.

18. The method of claim 7, wherein using the control system further comprises controlling the set of wirelessly-controlled and tracklessly-guided themed scenery vehicle platforms during a show to form a plurality of variously-shaped areas, presenting varying aspects of the mobile scenery at differing times to passengers.

19. The method of claim 7, wherein the set of wirelessly-controlled and tracklessly-guided themed scenery vehicle platforms are arranged as a maze, the method further comprising:
a) allowing for passenger choices of which paths within the maze to take; and
b) using the control system to change maze components arrangement as the vehicles progress.

20. The method of claim 7, further comprising:
a) allowing a passenger to dynamically interact with the ride show; and
b) making an area or ride show sequence responsive to the passenger's dynamic interaction.
